(19) United States
(12) Patent Application Publication
(10) Pub. No.: US 2025/0158441 A1
(43) Pub. Date: May 15, 2025

(54) CHARGING APPARATUS

(71) Applicant: DARFON ELECTRONICS CORP., TAOYUAN CITY (TW)

(72) Inventors: Yi-Nung LIU, TAOYUAN CITY (TW); Mao-Jung TSENG, TAOYUAN CITY (TW)

(21) Appl. No.: 18/949,538

(22) Filed: Nov. 15, 2024

Related U.S. Application Data
(60) Provisional application No. 63/598,948, filed on Nov. 15, 2023.

(30) Foreign Application Priority Data
May 6, 2024 (TW) 113116706

(51) Int. Cl. H02J 7/04; H01M 10/42; H01M 10/46; H02J 7/00

(52) U.S. Cl. CPC H02J 7/04; H01M 10/425; H01M 10/46; H02J 7/00036; H02J 7/0048; H02J 7/005; H01M 2010/4271; H02J 2207/20

(57) ABSTRACT

A charging apparatus functions in charging a rechargeable battery system, and includes an AC/DC converter, a controller, a DC output unit and a communication unit. The communication unit functions in receiving a current state of health (SOH) percentage and a current state of charge (SOC) percentage associated with the rechargeable battery system. The controller determines a selected SOC percentage from a plurality of predetermined SOC percentages in accordance with the current SOH percentage and a relationship stored therein. The controller controls the AC/DC converter to convert an AC power into a charging DC, and to output the charging DC to the DC output unit to charge the rechargeable battery system until the current SOC percentage equals the selected SOC percentage.

### CROSS-REFERENCE TO RELATED APPLICATION

This utility application claims priorities to U.S. Provisional Application Ser. No. 63/598,948, filed Nov. 15, 2023, and Taiwan Application Serial Number 113116706, filed May 6, 2024, the disclosures of which are incorporated herein by reference in their entireties.

### BACKGROUND OF THE INVENTION

### 1. Field of the Invention

The invention relates to a charging apparatus for charging a rechargeable battery system, and in particular, to a charging apparatus capable of automatically adjusting a selected state of charge (SOC) percentage to charge a rechargeable battery system.

### 2. Description of the Prior Art

Regarding the charging of rechargeable battery systems, such as lithium-ion batteries, the optimal battery capacity of current rechargeable battery systems is between 20% and 80%. The factors that affect the service life of rechargeable battery systems are temperature and charging capacity. In terms of charging capacity, and taking lithium-ion batteries as an example, most of the current rechargeable battery systems are set at a single charge capacity of 80%. This is because there is a difference of nearly five times between the service life of a rechargeable battery system at 80% capacity per charge and the service life of the rechargeable battery system at 100% capacity per charge. Referring to FIG. 1, FIG. 1 is a charging curve diagram of charging of a rechargeable battery system of a prior art to show the relationship between the state of charge (SOC) and the state of health (SOH) of the rechargeable battery system. As shown in FIG. 1, as the SOH percentage of the rechargeable battery system falls below 100%, the optimal battery capacity of the rechargeable battery system changes.

However, current charging apparatus charges the rechargeable battery system to a predetermined SOC percentage each time, for example, the SOC percentage is set to 80%.

### SUMMARY OF THE INVENTION

Accordingly, one scope of the invention is to provide a charging apparatus that can automatically adjust a selected SOC percentage to charge a rechargeable battery system. Thereby, when the rechargeable battery system is charged by the charging apparatus according to the invention, the service life of the rechargeable battery system can be increased.

A charging apparatus according to a first preferred embodiment of the invention is for charging a rechargeable battery system. The rechargeable battery system includes a battery management system and a first communication unit. The first communication unit is electrically connected to the battery management system. The battery management system calculates a current state of health (SOH) percentage and a current state of charge (SOC) percentage associated with the rechargeable battery system. The charging apparatus according to the first preferred embodiment of the invention includes an AC/DC converter, a controller, a DC output unit, and a second communication unit. The AC/DC converter is for receiving an AC power. The controller is electrically connected to the AC/DC converter. The controller therein stores a relationship between a plurality of predetermined SOC percentages and a plurality of predetermined SOH percentages. The DC output unit is respectively electrically connected to the AC/DC converter and the controller. The DC output unit is also electrically connected to the rechargeable battery system with a cable. The controller controls the DC output unit to turn on or off. The second communication unit is electrically connected to the controller. The second communication unit is capable of communicating with the first communication unit, and is for receiving the current SOH percentage and the current SOC through the first communication unit. The controller determines a selected SOC percentage from the plurality of predetermined SOC percentages in accordance with the current SOH percentage and the relationship. The controller controls the AC/DC converter to convert the AC power into a charging DC, and to output the charging DC to the DC output unit. The controller also controls the DC output unit to output the charging DC to charge the rechargeable battery system until the current SOC percentage equals the selected SOC percentage.

Further, the charging apparatus according to the first preferred embodiment of the invention also includes a detection unit. The detection unit is electrically connected to the controller, and electrically coupled to the cable. The detection unit is for detecting a charging voltage and a charging current. The controller controls the DC output unit to adjust an output voltage and an output current of the charging DC in accordance with the charging voltage and the charging current.

In one embodiment, the relationship is stored in the controller in a form of a look-up table.

A charging apparatus according to a second preferred embodiment of the invention is for charging a rechargeable battery system. The rechargeable battery system includes a battery management system and a first communication unit. The first communication unit is electrically connected to the battery management system. The battery management system calculates a current state of charge (SOC) percentage associated with the rechargeable battery system. The charging apparatus according to the second preferred embodiment of the invention includes an AC/DC converter, a controller, a DC output unit, and a second communication unit. The AC/DC converter is for receiving an AC power. The controller is electrically connected to the AC/DC converter. The DC output unit is respectively electrically connected to the AC/DC converter and the controller. The DC output unit is also electrically connected to the rechargeable battery system with a cable. The controller controls the DC output unit to turn on or off. The second communication unit is electrically connected to the controller. The second communication unit is capable of communicating with the first communication unit, and is for receiving and the current SOC through the first communication unit. The controller, according to a plurality of previous charging information, judges if a number of times a first selected SOC percentage being selected equals N, where N is an integer larger than 1. And if the controller judges that the number of times the first selected SOC percentage being selected equals N, the controller determines a second selected SOC, and controls the AC/DC converter to convert the AC power into a charging DC, and to output the charging DC to the DC output unit. The controller also controls the DC output unit to output the charging DC to charge the rechargeable battery system until the current SOC percentage equals the second selected SOC percentage. The second selected SOC percentage is larger than the first selected SOC percentage.

Further, if the controller judges that the number of times the first selected SOC percentage being selected is less than N, the controller controls the AC/DC converter to convert the AC power into the charging DC, and to output the charging DC to the DC output unit. The controller also controls the DC output unit to output the charging DC to charge the rechargeable battery system until the current SOC percentage equals the first selected SOC percentage.

Further, the battery management system also detects a battery cell voltage difference associated with the rechargeable battery system. The second communication unit also receives the battery cell voltage difference through the first communication unit. The controller also judges if the battery cell voltage difference is equal to or larger than a first threshold. And the controller judges that the battery cell voltage difference is equal to or larger than the first threshold, the controller determines the second selected SOC, and controls the AC/DC converter to convert the AC power into the charging DC and to output the charging DC to the DC output unit, and controls the DC output unit to output the charging DC to charge the rechargeable battery system until the battery cell voltage difference is less than a second threshold and the current SOC percentage equals the second selected SOC percentage.

A charging apparatus according to a third preferred embodiment of the invention is for charging a rechargeable battery system. The charging apparatus according to the third preferred embodiment of the invention includes an AC/DC converter, a controller, a DC output unit, a detection unit, and a selection unit. The AC/DC converter is for receiving an AC power. The controller is electrically connected to the AC/DC converter. The controller therein stores a relationship among a plurality of predetermined charging voltage, a plurality of predetermined charging current a plurality of predetermined state of charge (SOC) percentages. The DC output unit is respectively electrically connected to the AC/DC converter and the controller. The DC output unit is also electrically connected to the rechargeable battery system with a cable. The controller controls the DC output unit to turn on or off. The detection unit is electrically connected to the controller, and electrically coupled to the cable. The detection unit is for detecting a charging voltage and a charging current. The selection unit is electrically connected to the controller. The selection unit is operated by a user to input an instruction. The controller, responsive to the instruction, determines a selected SOC percentage, and determines a current SOC percentage from the plurality of predetermined SOC percentages in accordance with the charging voltage, the charging current and the relationship. The controller controls the AC/DC converter to convert the AC power into a charging DC, and to output the charging DC to the DC output unit. The controller also controls the DC output unit to output the charging DC to charge the rechargeable battery system until the current SOC percentage equals the selected SOC percentage.

In one embodiment, the relationship is stored in the controller in a form of a look-up table.

Different from the charging apparatus of the prior art, the charging apparatus according to the invention can automatically adjust a selected SOC percentage to charge a rechargeable battery system. Thereby, when the rechargeable battery system is charged by the charging apparatus according to the invention, the service life of the rechargeable battery system can be increased.

The advantage and spirit of the invention may be understood by the following recitations together with the appended drawings.

### BRIEF DESCRIPTION OF THE APPENDED DRAWINGS

FIG. 1 is a charging curve diagram of charging of a rechargeable battery system of a prior ar.

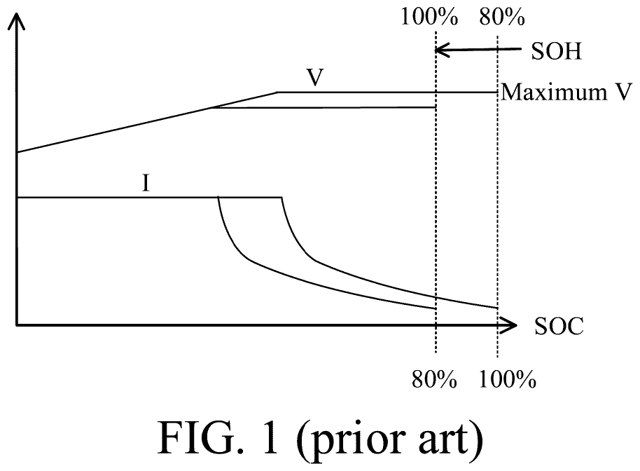

FIG. 2 is a schematic diagram of the architecture of a charging apparatus according to the first preferred embodiment of the invention and a rechargeable battery system charged therewith according to the first preferred embodiment of the invention.

FIG. 3 is a schematic diagram of the architecture of a charging apparatus according to the second preferred embodiment of the invention and a rechargeable battery system charged therewith according to the second preferred embodiment of the invention.

FIG. 4 is a charging curve diagram of an example of charging of the rechargeable battery system by the charging device according to the second preferred embodiment of the invention.

FIG. 5 is a schematic diagram of the architecture of a charging apparatus according to the third preferred embodiment of the invention and a rechargeable battery system charged therewith according to the third preferred embodiment of the invention.

### DETAILED DESCRIPTION OF THE INVENTION

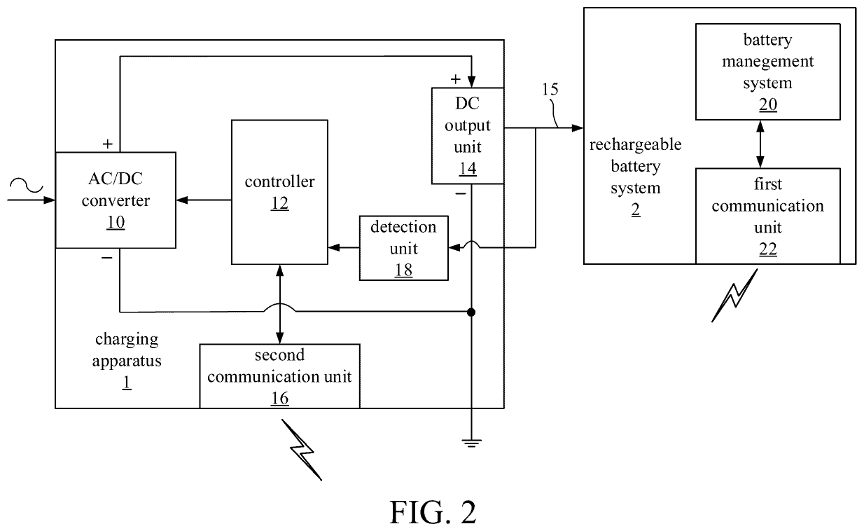

Referring to FIG. 2, the architecture of a charging apparatus 1 according to the first preferred embodiment of the invention and a rechargeable battery system 2 charged therewith the charging apparatus 1 according to the first preferred embodiment of the invention are schematically illustrated in FIG. 2.

As shown in FIG. 2, the charging apparatus 1 according to the first preferred embodiment of the invention is for charging the rechargeable battery system 2. The rechargeable battery system 2 includes a battery management system 20 and a first communication unit 22. The first communication unit 22 is electrically connected to the battery management system 20. The battery management system 20 calculates a current state of health (SOH) percentage and a current state of charge (SOC) percentage associated with the rechargeable battery system 2.

Also as shown in FIG. 2, the charging apparatus 1 according to the first preferred embodiment of the invention includes an AC/DC converter 10, a controller 12, a DC output unit 14, and a second communication unit 16.

The AC/DC converter 10 is for receiving an AC power. The controller 12 is electrically connected to the AC/DC converter 10. The controller 12 therein stores a relationship between a plurality of predetermined SOC percentages and a plurality of predetermined SOH percentages.

The DC output unit 14 is respectively electrically connected to the AC/DC converter 10 and the controller 12. The DC output unit 14 is also electrically connected to the rechargeable battery system 2 with a cable 15. The controller 12 controls the DC output unit 14 to turn on or off. The second communication unit 16 is electrically connected to the controller 12. The second communication unit 16 is capable of communicating with the first communication unit 22, and is for receiving the current SOH percentage and the current SOC through the first communication unit 22.

The controller 12 determines a selected SOC percentage from the plurality of predetermined SOC percentages in accordance with the current SOH percentage and the relationship. The controller 12 controls the AC/DC converter 10 to convert the AC power into a charging DC, and to output the charging DC to the DC output unit 14. The controller 12 also controls the DC output unit 14 to output the charging DC to charge the rechargeable battery system 2 until the current SOC percentage equals the selected SOC percentage. Thereby, the service life of the rechargeable battery system 2 can be increased.

Further, the charging apparatus 1 according to the first preferred embodiment of the invention also includes a detection unit 18. The detection unit 18 is electrically connected to the controller 12, and electrically coupled to the cable 15. The detection unit 18 is for detecting a charging voltage and a charging current. The controller 12 controls the DC output unit 14 to adjust an output voltage and an output current of the charging DC in accordance with the charging voltage and the charging current.

In one embodiment, the relationship is stored in the controller 12 in a form of a look-up table. In another embodiment, the relationship is stored in the controller 12 in a form of a formula. Referring to Table 1, an example of the relationship in in a form of a look-up table is shown in Table 1.

TABLE 1

| predetermined SOH percentage | predetermined SOC percentage |
|---|---|
| 100% | 80% |
| 95% | 85% |
| 90% | 90% |
| 85% | 95% |
| 80% | 100% |

According to the example shown in Table 1, when the current SOH percentage is 100%, the controller 12 determines that the selected SOC percentage is 80%. When the current SOH is 90%, the controller 12 determines that the selected SOC is 90%. When the current SOH is 80%, the controller 12 determines that the selected SOC is 100%.

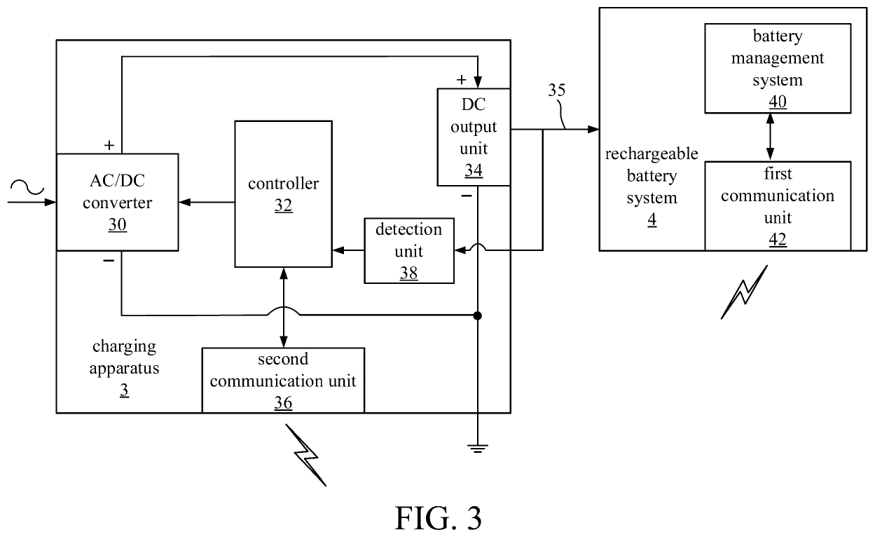

Referring to FIG. 3, the architecture of a charging apparatus 3 according to the second preferred embodiment of the invention and a rechargeable battery system 4 charged therewith the charging apparatus 3 according to the second preferred embodiment of the invention are schematically illustrated in FIG. 3.

As shown in FIG. 3, the charging apparatus 3 according to the second preferred embodiment of the invention is for charging the rechargeable battery system 4. The rechargeable battery system 4 includes a battery management system 40 and a first communication unit 42. The first communication unit 42 is electrically connected to the battery management system 40. The battery management system 40 calculates a current state of charge (SOC) percentage associated with the rechargeable battery system 4.

Also as shown in FIG. 3, the charging apparatus 3 according to the second preferred embodiment of the invention includes an AC/DC converter 30, a controller 32, a DC output unit 34, and a second communication unit 36.

The AC/DC converter 30 is for receiving an AC power. The controller 32 is electrically connected to the AC/DC converter 30. The DC output unit 34 is respectively electrically connected to the AC/DC converter 30 and the controller 32. The DC output unit 34 is also electrically connected to the rechargeable battery system 4 with a cable 35. The controller 32 controls the DC output unit 34 to turn on or off. The second communication unit 36 is electrically connected to the controller 32. The second communication unit 36 is capable of communicating with the first communication unit 42, and is for receiving and the current SOC through the first communication unit 42.

The controller 32, according to a plurality of previous charging information, judges if a number of times a first selected SOC percentage being selected equals N, where N is an integer larger than 1. And if the controller 32 judges that the number of times the first selected SOC percentage being selected equals N, the controller 32 determines a second selected SOC, and controls the AC/DC converter 30 to convert the AC power into a charging DC, and to output the charging DC to the DC output unit 34. The controller 32 also controls the DC output unit 34 to output the charging DC to charge the rechargeable battery system 4 until the current SOC percentage equals the second selected SOC percentage. The second selected SOC percentage is larger than the first selected SOC percentage. Thereby, the service life of the rechargeable battery system 4 can be increased.

In an example, the first selected SOC percentage is 80% and the second selected SOC percentage is 100%.

Further, if the controller 32 judges that the number of times the first selected SOC percentage being selected is less than N, the controller 32 controls the AC/DC converter 30 to convert the AC power into the charging DC, and to output the charging DC to the DC output unit 34. The controller 32 also controls the DC output unit 34 to output the charging DC to charge the rechargeable battery system 4 until the current SOC percentage equals the first selected SOC percentage.

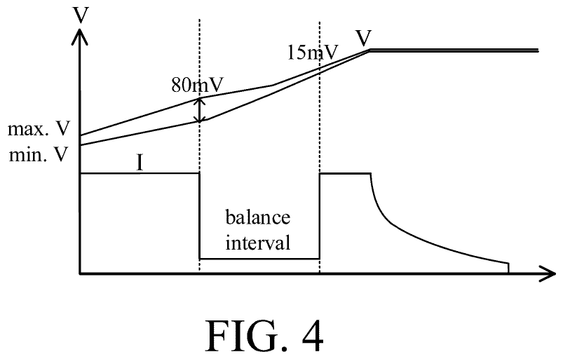

Further, the battery management system 40 also detects a battery cell voltage difference associated with the rechargeable battery system 4. The second communication unit 36 also receives the battery cell voltage difference through the first communication unit 42. The controller 32 also judges if the battery cell voltage difference is equal to or larger than a first threshold. In one embodiment, the first threshold is equal to 80 mV. And the controller 32 judges that the battery cell voltage difference is equal to or larger than the first threshold, the controller 32 determines the second selected SOC, and controls the AC/DC converter 30 to convert the AC power into the charging DC and to output the charging DC to the DC output unit 34, and controls the DC output unit 34 to output the charging DC to charge the rechargeable battery system 4 until the battery cell voltage difference is less than a second threshold and the current SOC percentage equals the second selected SOC percentage. In one embodiment, the second threshold is equal to 15 mV. Referring to FIG. 4, FIG. 4 is a charging curve diagram of an example of charging of the rechargeable battery system 4 by the charging device 3 according to the second preferred embodiment of the invention.

According to the charging curve shown in FIG. 4, when the controller 32 determines that the battery cell voltage difference is greater than 80 mV, the controller 32 controls the AC/DC converter 30 to reduce the charging current and to cooperate with the internal balancing mechanism of the rechargeable battery system 4, so that the battery cell voltage difference is slowly reduced during low current charging. When the battery cell voltage differential is less than 15 mV, the controller 32 controls the AC/DC converter 30 to resume normal current charging and controls charging of the rechargeable battery system 4 until the current SOC percentage is equal to the first selected SOC percentage (e.g., the first selected SOC percentage is 100%). In one embodiment, the second threshold is less than the first threshold.

Further, the charging apparatus 3 according to the second preferred embodiment of the invention also includes a detection unit 38. The detection unit 38 is electrically connected to the controller 32, and electrically coupled to the cable 35. The detection unit 38 is for detecting a charging voltage and a charging current. The controller 32 controls the DC output unit 34 to adjust an output voltage and an output current of the charging DC in accordance with the charging voltage and the charging current.

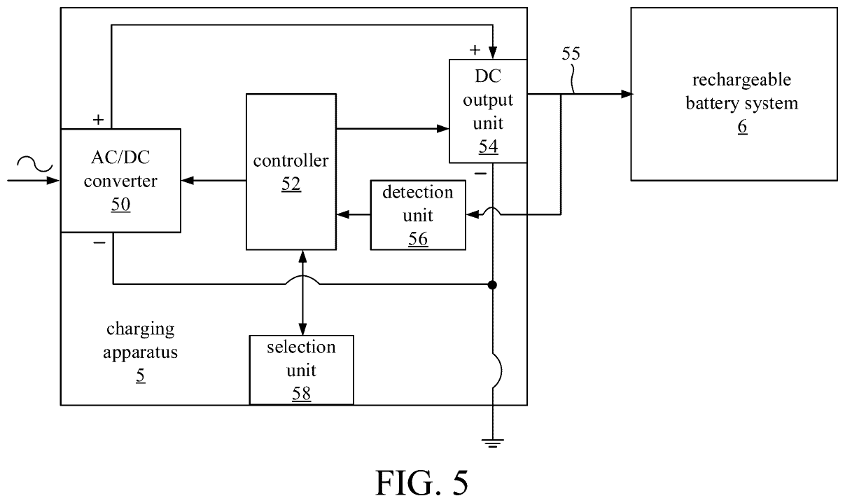

Referring to FIG. 5, the architecture of a charging apparatus 5 according to the second preferred embodiment of the invention and a rechargeable battery system 6 charged therewith the charging apparatus 5 according to the second preferred embodiment of the invention are schematically illustrated in FIG. 5.

As shown in FIG. 5, the charging apparatus 5 according to the third preferred embodiment of the invention is for charging the rechargeable battery system 6.

The charging apparatus 5 according to the third preferred embodiment of the invention includes an AC/DC converter 50, a controller 52, a DC output unit 54, a detection unit 56, and a selection unit 58.

The AC/DC converter 50 is for receiving an AC power. The controller 52 is electrically connected to the AC/DC converter 50. The controller 52 therein stores a relationship among a plurality of predetermined charging voltage, a plurality of predetermined charging current a plurality of predetermined state of charge (SOC) percentages.

The DC output unit 54 is respectively electrically connected to the AC/DC converter 50 and the controller 52. The DC output unit 54 is also electrically connected to the rechargeable battery system 6 with a cable 55. The controller 52 controls the DC output unit 54 to turn on or off. The detection unit 56 is electrically connected to the controller 52, and electrically coupled to the cable 55. The detection unit 56 is for detecting a charging voltage and a charging current. The selection unit 58 is electrically connected to the controller 52. The selection unit 58 is operated by a user to input an instruction. The controller 52, responsive to the instruction, determines a selected SOC percentage, and determines a current SOC percentage from the plurality of predetermined SOC percentages in accordance with the charging voltage, the charging current and the relationship. The controller 52 controls the AC/DC converter 50 to convert the AC power into a charging DC, and to output the charging DC to the DC output unit 54. The controller 52 also controls the DC output unit 54 to output the charging DC to charge the rechargeable battery system 6 until the current SOC percentage equals the selected SOC percentage. Thereby, the service life of the rechargeable battery system 6 can be increased.

In one embodiment, the relationship is stored in the controller 52 in a form of a look-up table. In another embodiment, the relationship is stored in the controller 52 in a form of a formula.

With the detailed description of the above preferred embodiments of the invention, it is clear to understand that the charging apparatus according to the invention can automatically adjust a selected SOC percentage to charge a rechargeable battery system. Thereby, when the rechargeable battery system is charged by the charging apparatus according to the invention, the service life of the rechargeable battery system can be increased.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A charging apparatus for charging a rechargeable battery system comprising a battery management system and a first communication unit, the first communication unit being electrically connected to the battery management system, the battery management system calculating a current state of health (SOH) percentage and a current state of charge (SOC) percentage associated with the rechargeable battery system, said charging apparatus comprising:
an AC/DC converter, for receiving an AC power;
a controller, electrically connected to the AC/DC converter, the controller therein storing a relationship between a plurality of predetermined SOC percentages and a plurality of predetermined SOH percentages;
a DC output unit, respectively electrically connected to the AC/DC converter and the controller, the DC output unit being also electrically connected to the rechargeable battery system with a cable, wherein the controller controls the DC output unit to turn on or off; and
a second communication unit, electrically connected to the controller, the second communication unit being capable of communicating with the first communication unit and being for receiving the current SOH percentage and the current SOC through the first communication unit,
wherein the controller determines a selected SOC percentage from the plurality of predetermined SOC percentages in accordance with the current SOH percentage and the relationship, the controller controls the AC/DC converter to convert the AC power into a charging DC and to output the charging DC to the DC output unit, and controls the DC output unit to output the charging DC to charge the rechargeable battery system until the current SOC percentage equals the selected SOC percentage.

2. The charging apparatus of claim 1, further comprising:
a detection unit, electrically connected to the controller and electrically coupled to the cable, the detection unit being for detecting a charging voltage and a charging current, wherein the controller controls the DC output unit to adjust an output voltage and an output current of the charging DC in accordance with the charging voltage and the charging current.

3. The charging apparatus of claim 1, wherein the relationship is stored in the controller in a form of a look-up table or a form of a formula.

4. A charging apparatus for charging a rechargeable battery system comprising a battery management system and a first communication unit, the first communication unit being electrically connected to the battery management system, the battery management system calculating a current state of charge (SOC) percentage associated with the rechargeable battery system, said charging apparatus comprising:
an AC/DC converter, for receiving an AC power;
a controller, electrically connected to the AC/DC converter;
a DC output unit, respectively electrically connected to the AC/DC converter and the controller, the DC output unit being also electrically connected to the rechargeable battery system with a cable, wherein the controller controls the DC output unit to turn on or off; and
a second communication unit, electrically connected to the controller, the second communication unit being capable of communicating with the first communication unit and being for receiving the current SOC through the first communication unit,
wherein the controller, according to a plurality of previous charging information, judges if a number of times a first selected SOC percentage being selected equals N, and if yes, the controller determines a second selected SOC, and controls the AC/DC converter to convert the AC power into a charging DC and to output the charging DC to the DC output unit, and controls the DC output unit to output the charging DC to charge the rechargeable battery system until the current SOC percentage equals the second selected SOC percentage, N is an integer larger than 1, the second selected SOC percentage is larger than the first selected SOC percentage.

5. The charging apparatus of claim 4, wherein if the controller judges that the number of times the first selected SOC percentage being selected is less than N, the controller controls the AC/DC converter to convert the AC power into the charging DC and to output the charging DC to the DC output unit, and controls the DC output unit to output the charging DC to charge the rechargeable battery system until the current SOC percentage equals the first selected SOC percentage.

6. The charging apparatus of claim 4, further comprising:
a detection unit, electrically connected to the controller and electrically coupled to the cable, the detection unit being for detecting a charging voltage and a charging current, wherein the controller controls the DC output unit to adjust an output voltage and an output current of the charging DC in accordance with the charging voltage and the charging current.

7. The charging apparatus of claim 4, wherein the battery management system also detects a battery cell voltage difference associated with the rechargeable battery system, the second communication unit also receives the battery cell voltage difference through the first communication unit, the controller also judges if the battery cell voltage difference is equal to or larger than a first threshold, and if yes, the controller determines the second selected SOC, and controls the AC/DC converter to convert the AC power into the charging DC and to output the charging DC to the DC output unit, and controls the DC output unit to output the charging DC to charge the rechargeable battery system until the battery cell voltage difference is less than a second threshold and the current SOC percentage equals the second selected SOC percentage.

8. The charging apparatus of claim 7, wherein the second threshold is less than the first threshold.

9. A charging apparatus for charging a rechargeable battery system, said charging apparatus comprising:
an AC/DC converter, for receiving an AC power;
a controller, electrically connected to the AC/DC converter, the controller therein storing a relationship among a plurality of predetermined charging voltage, a plurality of predetermined charging current a plurality of predetermined state of charge (SOC) percentages;
a DC output unit, respectively electrically connected to the AC/DC converter and the controller, the DC output unit being also electrically connected to the rechargeable battery system with a cable, wherein the controller controls the DC output unit to turn on or off;
a detection unit, electrically connected to the controller and electrically coupled to the cable, the detection unit being for detecting a charging voltage and a charging current; and
a selection unit, electrically connected to the controller, the selection unit being operated by a user to input an instruction,
wherein the controller, responsive to the instruction, determines a selected SOC percentage, and determines a current SOC percentage from the plurality of predetermined SOC percentages in accordance with the charging voltage, the charging current and the relationship, the controller controls the AC/DC converter to convert the AC power into a charging DC and to output the charging DC to the DC output unit, and controls the DC output unit to output the charging DC to charge the rechargeable battery system until the current SOC percentage equals the selected SOC percentage.

10. The charging apparatus of claim 9, wherein the relationship is stored in the controller in a form of a look-up table or a form of a formula.
